(19) United States
(12) Patent Application Publication
(10) Pub. No.: US 2012/0099449 A1
(43) Pub. Date: Apr. 26, 2012

(54) SPATIAL RESUSE IN A WIRELESS NETWORK

(75) Inventors: Ritesh K. Madan, Jersey City, NJ (US); Ashwin Sampath, Princeton, NJ (US); Ahmed K. Sadek, San Diego, CA (US)

(73) Assignee: QUAL COMM Incorporated, San Diego, CA (US)

(21) Appl. No.: 13/228,691

(22) Filed: Sep. 9, 2011

Related U.S. Application Data
(60) Provisional application No. 61/386,918, filed on Sep. 27, 2010.

(51) Int. Cl. H04W 24/00; H04W 52/16

(52) U.S. Cl. 370/252

(57) ABSTRACT

In a first method, a first apparatus determines a channel gain to a second apparatus with which the first apparatus is communicating. The first apparatus determines interferer backoff information that ensures an interference level at the first apparatus such that a signal received from the second apparatus can be decoded reliably. The interferer backoff information is determined based on the channel gain. The first apparatus transmits information based on the interferer backoff information in a message to the second apparatus. In a second method, a first apparatus in communication with a second apparatus determines a channel gain to a third apparatus with which the first apparatus can potentially interfere. The first apparatus receives a message from the third apparatus. The message includes interferer backoff information. The first apparatus determines a power for transmitting a signal to the second apparatus based on the interferer backoff information and the channel gain.

### CROSS-REFERENCE TO RELATED APPLICATION(S)

This application claims the benefit of U.S. Provisional Application Ser. No. 61/386,918, entitled “Spatial Reuse in a Wireless Network,” filed on Sep. 27, 2010, which is expressly incorporated by reference herein in its entirety.

### BACKGROUND

1. Field

The present disclosure relates generally to communication systems, and more particularly, to spatial reuse in a wireless network.

2. Background

In Wi-Fi there are two main mechanisms involved in interference management: physical carrier sense and request to send (RTS) and clear to send (CTS) collision avoidance. In physical carrier sense, an interferer may sense the medium, and if the medium is sensed to be busy, the transmitter waits for the ongoing transmission to finish, waits for a random amount of backoff time, and then tries to transmit. If the medium is determined to be idle, the transmitter may proceed to transmit. In RTS/CTS collision avoidance, a transmitter that receives a RTS and/or CTS defers transmission until the data transmission corresponding to the RTS/CTS finishes.

For the physical carrier sense, the medium is deemed busy if the transmitter receives data transmissions from interferers at powers as low as around −80 dBm. For the RTS/CTS mechanism, all transmitters within reception range of a transmitting device that sends the RTS and/or a receiving device that sends the CTS do not transmit until the corresponding data transmission is over. This has at least two drawbacks. First, the transmitter may back off from transmitting when the transmitter is close to the transmitting device and far from the receiving device. Backing off in such a situation may be unnecessary. Second, a transmitter may back off even when the receiving device's signal to interference plus noise ratio (SINR) would be high when the transmitter transmits. Backing off in such a situation leads to sub-optimal spatial reuse and loss of overall capacity in the network. As such, a need exists for methods of spatial reuse in a wireless networks, such as Wi-Fi wireless networks.

### SUMMARY

In an aspect of the disclosure, a method of operating a first wireless device includes determining a channel gain to a second wireless device with which the first wireless device is communicating. In addition, the method includes determining interferer backoff information that ensures an interference level at the first wireless device such that a signal received from the second wireless device can be decoded reliably. The interferer backoff information is determined based on the channel gain. Furthermore, the method includes transmitting information based on the interferer backoff information in a message to the second wireless device.

In an aspect of the disclosure, a method of operating a first wireless device in communication with a second wireless device includes determining a channel gain to a third wireless device with which the first wireless device can potentially interfere. In addition, the method includes receiving a message from the third wireless device. The message includes interferer backoff information. Furthermore, the message includes determining a power for transmitting a signal to the second wireless device based on the interferer backoff information and the channel gain.

### BRIEF DESCRIPTION OF THE DRAWINGS

FIG. 1 is a diagram illustrating an example of a hardware implementation for an apparatus employing a processing system.

FIG. 2 is a diagram illustrating communication between Wi-Fi enabled devices.

FIG. 3 is a diagram illustrating a timing structure with RTS, CTS, data, and acknowledgement (ACK) transmissions.

FIG. 4 are diagrams illustrating exemplary RTS, CTS, and ACK control frames.

FIG. 5 is a diagram for illustrating a first exemplary method.

FIG. 6 is a diagram for illustrating a second exemplary method.

FIG. 7 is a diagram for illustrating a third exemplary method.

FIG. 8 is a flow chart of a first method of wireless communication.

FIG. 9 is a flow chart of a second method of wireless communication.

FIG. 10 is a flow chart of a third method of wireless communication.

FIG. 11 is a conceptual block diagram illustrating the functionality of an exemplary apparatus.

FIG. 12 is a conceptual block diagram illustrating the functionality of another exemplary apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Those skilled in the art will recognize how best to implement the described functionality presented throughout this disclosure depending on the particular application and the overall design constraints imposed on the overall system.

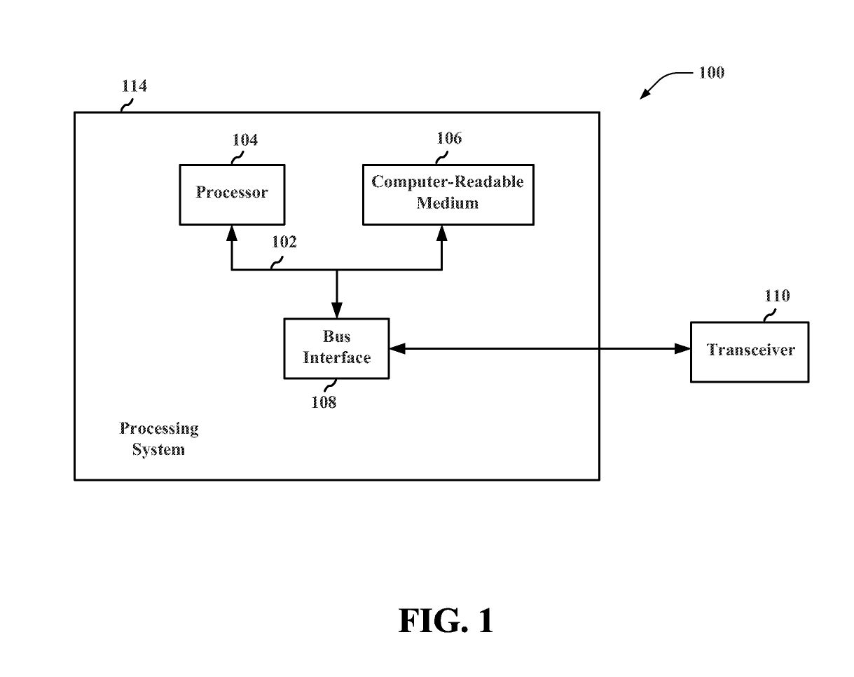

FIG. 1 is a conceptual diagram illustrating an example of a hardware implementation for an apparatus 100 employing a processing system 114. The processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors and/or hardware modules, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatuses over a transmission medium.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

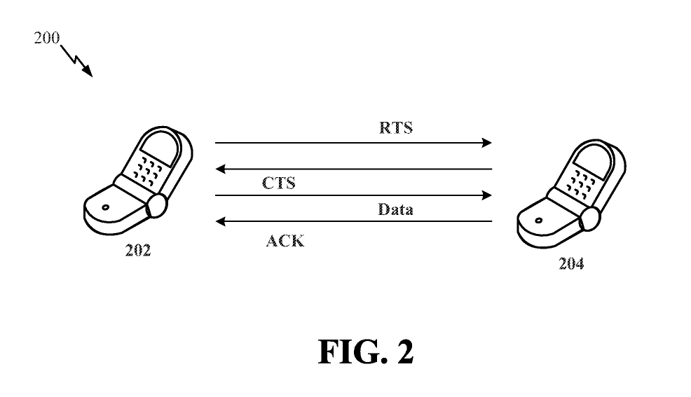

FIG. 2 is a diagram 200 illustrating communication between Wi-Fi enabled devices. As shown in FIG. 2, the wireless device 202 and the wireless device 204 are in communication. When the wireless device 202 has data to send to the wireless device 204, the wireless device 202 first sends an RTS message to the wireless device 204. When the wireless device 204 determines that it may receive the data corresponding to the RTS message, the wireless device 204 sends a CTS message to the wireless device 202. The wireless device 202 then sends the data to the wireless device 204. The wireless device responds with an ACK or negative ACK (NACK) in an ACK message to indicate whether the data was successfully received.

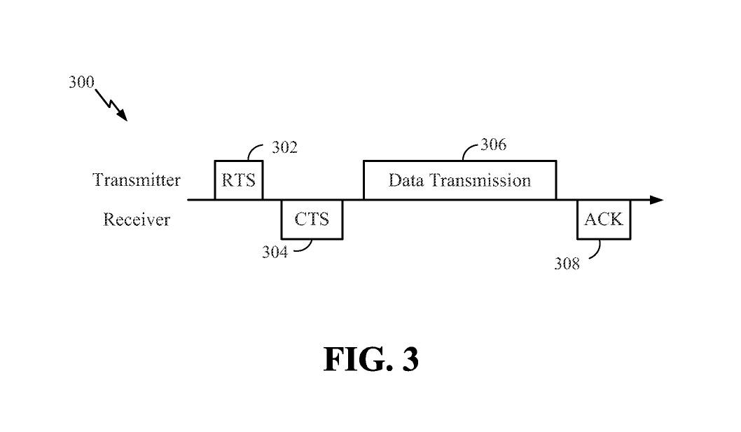

FIG. 3 is a diagram 300 illustrating a timing structure with RTS, CTS, data, and ACK transmissions. As shown in FIG. 3, the transmitter wireless device with data to transmit sends an RTS message 302 in an RTS frame. After receiving the RTS message 302, the receiver wireless device waits a short interframe space (SIFS) interval and sends a CTS message 304 in a CTS frame. After receiving the CTS message 304, the transmitter waits a SIFS interval and sends the data transmission 306. After receiving the data transmission 306, the receiver waits a SIFS interval and sends an ACK/NACK 308 in the ACK subframe.

Other timing structures are possible. The data transmissions 306 may be split into a plurality of data transmissions. Additional RTS 302, CTS 304, and data transmissions 306 may follow a particular data transmission 306 before an ACK/NACK 308. In such a configuration, the transmitter may send an ACK request (ACKREQ) after multiple data transmissions. The receiver may then respond to the ACKREQ with the ACK/NACK 308.

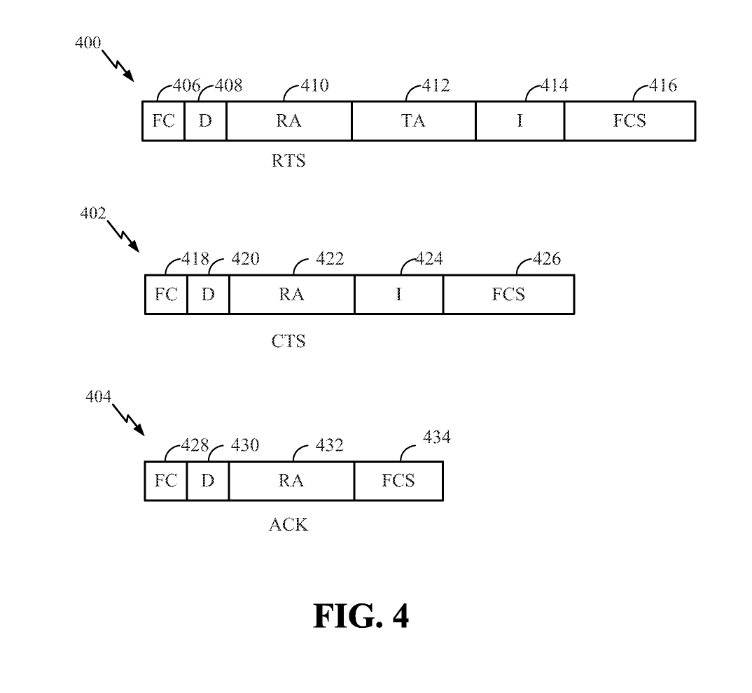

FIG. 4 are diagrams 400, 402, 404 illustrating exemplary RTS, CTS, and ACK control frames, respectively. An RTS frame 400 is a fixed length and includes a frame control (FC) field 406, a duration (D) field 408, a receiver address (RA) field 410, a transmitter address (TA) field 412, an interference (I) field 414, and a frame check sum (FCS) field 416. The frame control field 406 identifies the frame as an RTS frame. For example, the frame control field 406 may be set to “1011” or some other value to indicate that the frame is an RTS frame. The duration field 408 includes a timer called a network allocation vector (NAV) that indicates the total time of the SIFS-CTS-SIFS-DATA-SIFS-ACK. The interference field 414 indicates an amount of interference that the transmitter can tolerate while receiving the CTS frame 402 and the ACK frame 404. The interference field 414 alerts other wireless devices that receive the RTS message 400 that they may transmit when a CTS or ACK is expected as long as they do not exceed an interference value that can be computed based on the value in the interference field 414. The frame check sum field 416 allows the receiver to determine if the bits in the proceeding fields were received correctly.

A CTS frame 402 is a fixed length and includes a frame control (FC) field 418, a duration (D) field 420, a receiver address (RA) field 422, an interference (I) field 424, and a frame check sum (FCS) field 426. The frame control field 418 identifies the frame as a CTS frame. For example, the frame control field 418 may be set to “1100” or some other value to indicate that the frame is a CTS frame. The duration field 420 includes a NAV that indicates the total time of the SIFS-DATA-SIFS-ACK. The interference field 424 indicates an amount of interference that the receiver can tolerate while receiving the data transmission 306. The interference field 424 alerts other wireless devices that receive the CTS message 402 that they may transmit when a data transmission is expected as long as they do not exceed an interference value that can be computed based on the value in the interference field 424. The frame check sum field 426 allows the transmitter to determine if the bits in the proceeding fields were received correctly.

An ACK frame 404 is a fixed length and includes a frame control (FC) field 428, a duration (D) field 430, a receiver address (RA) field 432, and a frame check sum (FCS) field 434. The frame control field 428 identifies the frame as an ACK frame. For example, the frame control field 428 may be set to “1101” or some other value to indicate that the frame is an ACK frame. The duration field 430 may be set to 0 to indicate that the transmission is complete. The frame check sum field 434 allows the transmitter to determine if the bits in the proceeding fields were received correctly.

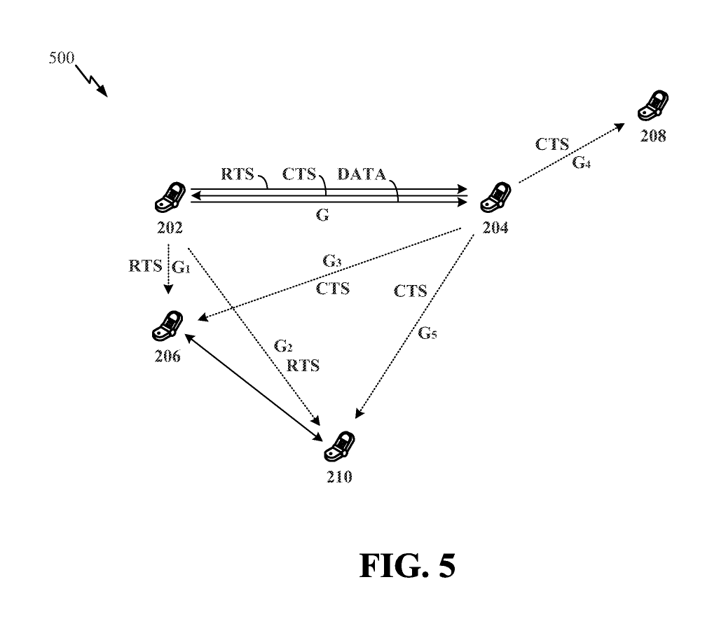

FIG. 5 is a diagram 500 for illustrating a first exemplary method. As shown in FIG. 5, the wireless device 202 is in communication with the wireless device 204. The wireless device 202 sends an RTS message to the wireless device 204. The RTS message is also received by the wireless device 206 and the wireless device 210. The wireless device 204 responds with a CTS message. The CTS message is also received by the wireless devices 206, 208, 210. As discussed supra, both the RTS message and the CTS message include an interference field to indicate an interference level margin that would be tolerable while receiving control information and/or data. Alternatively, the interference field may include a channel gain (receive power) threshold such that an interferer which has channel gain to the RTS/CTS transmitter (received power of RTS/CTS) higher than the threshold does not transmit for the packet transmission which the RTS/CTS protects.

To determine the interference level margin, the wireless device 202 determines a channel gain G to the wireless device 204. The channel gain may be determined based on a previously received RTS, CTS, data transmission, ACK, or other transmission from the wireless device 204. The interference level margin is determined based on the channel gain G and is an interference level (e.g., a maximum interference level) that would allow a CTS and an ACK received from the wireless device 204 to be successfully decoded by the wireless device 202. When the wireless device 202 has data to transmit to the wireless device 204 and the wireless device 202 can send an RTS message without causing too much interference to another link of two communicating wireless devices, the wireless device 202 includes information based on the interference level margin in the interference field of the RTS message and transmits/broadcasts the RTS message to the wireless device 204.

To determine the interference level margin, the wireless device 204 determines the channel gain G to the wireless device 202. The channel gain may be determined based on a previously received RTS, CTS, data transmission, ACK, or other transmission from the wireless device 202. The interference level margin is determined based on the channel gain G and is an interference level (e.g., a maximum interference level) that would allow a data transmission received from the wireless device 202 to be successfully decoded by the wireless device 204. When the wireless device 204 is clear to receive a data transmission from the wireless device 202 and the wireless device 204 can send a CTS message without causing too much interference to another link of two communicating wireless devices, the wireless device 204 includes information based on the interference level margin in the interference field of the CTS message and transmits/broadcasts the CTS message to the wireless device 202.

The information included in the interference field of the RTS and CTS messages may be a channel gain threshold Gₜₕ determined based on the channel gain G. Generally, the channel gain threshold Gₜₕ is a function of the channel gain G and the channel gain Gᵢ between interfering wireless devices and the RTS or CTS transmitter for i=1, 2, . . . , N:

Gₜₕ=f(G,G₁,G₂, . . . ,G_{N}),

where Gᵢ is the channel gain for the interferer of N interferers. For example, the wireless device 202 may include a channel gain threshold Gₜₕ in the interference field of a transmitted RTS message in which the channel gain threshold Gₜₕ is a function of the channel gain G and the channel gains G₁, G₂. In addition, the wireless device 204 may include a channel gain threshold Gₜₕ in the interference field of a transmitted CTS message in which the channel gain threshold Gₜₕ is a function of the channel gain G and the channel gains G₃, G₄, G₅. The channel gain threshold Gₜₕ need not be a function of the channel gain between the interferers and the RTS/CTS transmitter. For example, the channel gain threshold Gₜₕ may equal G minus 10 dB.

The wireless device 206 receives the RTS message from the wireless device 202. The RTS message includes the interference level (or the channel gain threshold Gₜₕ) below which the wireless device 202 can successfully decode the CTS and ACK messages. The wireless device 206 determines the channel gain G₁ to the wireless device 202. Based on the interference level in the RTS message and the channel gain G₁, the wireless device 206 determines a power for transmitting a signal to the wireless device 210 with which the wireless device 206 is communicating. The wireless device 206 may lower the power at which the device communicates with the wireless device 210 or may refrain from communicating with the wireless device 210 while the wireless device receives the CTS and ACK messages in order to avoid causing interference greater than the interference level. If the wireless device 206 does not adjust its power, the wireless device 206 may refrain from transmitting a signal to the wireless device 210 while the wireless device 202 receives the CTS and ACK messages if the interference caused to the wireless device 202 by transmitting the signal is greater than the interference level. For example, if the channel gain G₁>Gₜₕ, the wireless device 206 may refrain from transmitting the signal in order to avoid causing interference to the wireless device 202 that could prevent the wireless device 202 from successfully decoding the CTS and/or ACK messages.

The wireless device 206 receives the CTS message from the wireless device 204. The CTS message includes the interference level, below which the wireless device 204 can successfully decode a data transmission from the wireless device 202 (alternatively, the CTS message includes the channel gain threshold Gₜₕ). The wireless device 206 determines the channel gain G₂ to the wireless device 204. Based on the interference level in the CTS message (or the threshold Gₜₕ) and the channel gain G₂, the wireless device 206 determines a power for transmitting a signal to the wireless device 210 with which the wireless device 206 is communicating. The wireless device 206 may adjust the power such that an interference caused by the transmission of the signal is less than the interference level. By lowering the power at which the signal is transmitted to the wireless device 210, the wireless device 206 can avoid causing interference that could prevent the wireless device 204 from successfully decoding a data transmission from the wireless device 202. Alternatively, the wireless device 206 may refrain from communicating with the wireless device 210 while the wireless device 204 receives the data transmission.

In one configuration, if communicating with the wireless device 210 at the determined power would cause interference greater than the interference level to the wireless device 202 while the device receives the CTS and ACK messages, the wireless device 206 refrains from the communication rather than reduce its transmission power in order to avoid causing excessive interference. In addition, if communicating with the wireless device 210 at the determined power would cause interference greater than the interference level to the wireless device 204 while the device receives a data transmission, the wireless device 206 reduces its transmission power rather than refrain from the communication in order to avoid causing excessive interference. In one configuration, if communication by the wireless device 206 with the wireless device 210 at the determined power would cause interference greater than the interference level to the wireless device 202 and/or wireless device 204, the wireless device 206 refrains from the communication during ACK messages sent from the wireless device 204 to the wireless device 202 only and reduces its transmission power for CTS messages and data transmissions, as such a configuration improves spatial reuse while avoiding causing interference to the critical ACK messages.

In a second exemplary method, the CTS message may also include a rate at which the wireless device 204 expects to receive a transmission from the wireless device 202. Based on the channel gain G₁, the wireless device 206 may determine a degradation to the rate due to a transmission of the signal to the wireless device 210. The wireless device 206 may then determine a rate for the transmission of the signal to the wireless device 210. If the rate for the transmission of the signal to the wireless device 210 is greater than the degradation to the rate for the communication between the wireless devices 202, 204, the wireless device 206 may determine to transmit the signal to the wireless device 210. If the rate for the transmission of the signal to the wireless device 210 is less than the degradation to the rate for the communication between the wireless devices 202, 204, the wireless device 206 may determine to refrain from transmitting the signal to the wireless device 210.

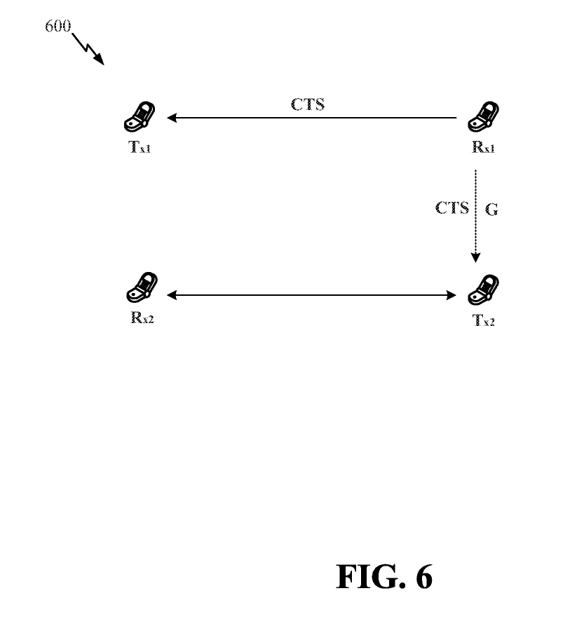

FIG. 6 is a diagram 600 for illustrating the second exemplary method as discussed supra. According to the method, the receiver communicates certain information to the interferer. The interferer then trades a data rate with the receiver with which it interferes and a data rate with the receiver that the interferer serves. The mechanism is illustrated in FIG. 6. As shown in FIG. 6, link Tₓ₁, Rₓ₁ are communicating and link Tₓ₂, Rₓ₂ are communicating. The receiver Rₓ₁ sends a CTS message to the transmitter Tₓ₁. The CTS message is received by the potential interferer Tₓ₂. The CTS message is sent at fixed power. As such, Tₓ₂ may determine the channel gain G based on the power of the received CTS message. The CTS message includes the SINR or equivalently the rate at which Rₓ₁ expects to receive the transmission from Tₓ₁. When Tₓ₂ has data to send to Rₓ₂, Tₓ₂ determines (1) the rate at which Tₓ₂ can transmit to Rₓ₂ and (2) the degradation to the rate to Rₓ₁ if Tₓ₂ transmits. With respect to (1), the rate at which Tₓ₂ can transmit to Rₓ₂ can be based on past transmissions. Tₓ₂ may use a conservative estimate of the rate so as not to overestimate the gain to Rₓ₂ at the cost of causing interference to on-going transmissions from Tₓ₁ to Rₓ₁. With respect to (2), the degradation in the rate to Rₓ₁ if Tₓ₂ transmits may be estimated based on the channel gain G and the rate in the CTS message (which may be periodically broadcast by Rₓ₁ to provide a more accurate estimate). Tₓ₂ may then transmit to Rₓ₂ if the rate at which it may transmit to Rₓ₂ is greater than the degradation in the rate to Rₓ₁ from Tₓ₁ assuming Tₓ₂ transmits. When power control is used (e.g., when transmitters may transmit at different powers), Tₓ₂ may choose a power level at which the estimated sum of rates over the two links is maximized.

Two additional examples are provided with respect to rate information being included in CTS messages. In a first example, the sequence of transmissions between Tₓ₁ and Rₓ₁ is RTS, CTS, data, ACK. Assume the SINR when Tₓ₁ transmits data to Rₓ₁ is 8 dB when Tₓ₂ is silent. The CTS sent by Rₓ₁ contains (i) the rate at which Rₓ₁ will receive data from Tₓ₁ (assume this is 6 Mbps, which corresponds to a minimum SINR for successful decoding of 3 dB), and (ii) SINR expected when Tₓ₂ (and other interferers) is silent (assumed to be 8 dB). When Tₓ₂ receives the CTS message from Rₓ₁, Tₓ₂ estimates the maximum transmission power P_{success} such that the SINR at Rₓ₁ is greater than 3 dB. Tₓ₂ performs the estimation assuming a noise floor at Rₓ₁ (e.g., 5 dB over thermal noise). Tₓ₂ then compares the following two values:
Rate at which Tₓ₂ can transmit to Rₓ₂ reliably at power P_{success}+6 Mbps+Δ
Rate at which Tₓ₂ can transmit to Rₓ₂ at maximum transmission power (which can cause Tₓ₁'s transmission to fail)
   Tₓ₂ determines whether to transmit at a maximum transmission power or a power equal to P_{success} based on which quantity is greater.

In a second example, the sequence of transmissions between Tₓ₁ and Rₓ₁ is RTS, CTS, listen, data, ACK. During the listen time, interferers can transmit (e.g., CTS or a new Wi-Fi message) so that Rₓ₁ and Tₓ₁ can sense energy and estimate the decisions of the interferers on whether they will remain silent. Between the listen time and data transmission, an explicit SINR feedback from Rₓ₁ to Tₓ₁ may be transmitted so that Tₓ₁ can pick the rate to transmit based on the SINR measured at Rₓ₁ during the listen period. If too much interference is sensed during the listen period, Tₓ₁ may abandon the opportunity to transmit a packet, and re-contend for the medium. The CTS message may carry the same information as in the first example. Tₓ₂ computes the power level P_{success} at which at least the minimum rate option transmission from Tₓ₁ to Rₓ₁ is successful. Then Tₓ₂ computes for all power levels:
Rate at which Tₓ₂ can transmit to Rₓ₂ reliably at power P<P_{success} plus rate at which Tₓ₁ can transmit to Rₓ₁ if Tₓ₂ transmits at power P plus Δ
Rate at which Tₓ₂ can transmit to Rₓ₂ reliably at power P>P_{success} plus rate at which Tₓ₁ can transmit to Rₓ₁ if Tₓ₂ transmits at power P
   Tₓ₂ then picks power level which maximizes the total rate (which may include Δ depending on power level). Tₓ₂ signals this power level during the listen period.

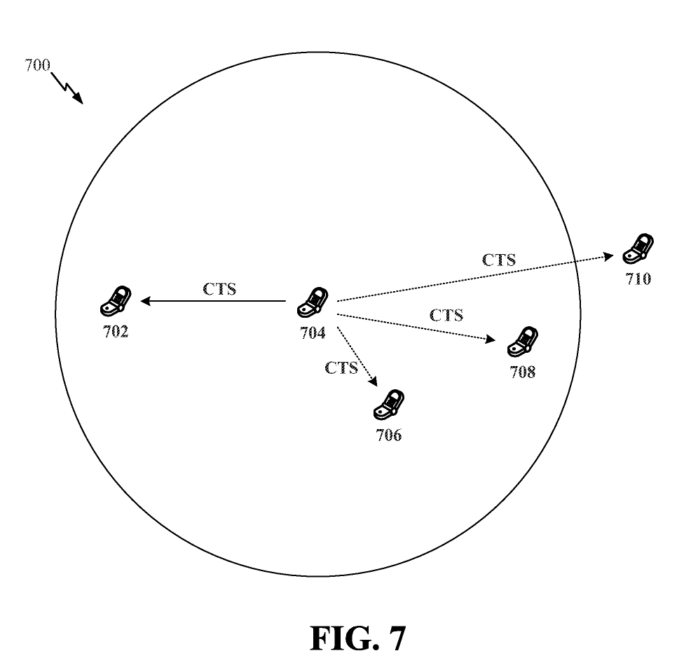

FIG. 7 is a diagram 700 for illustrating a third exemplary method. Rather than transmit an interference value in the CTS messages, wireless device 704 may transmit interference information through a transmission power of the CTS messages. The power at which the potentially interfering wireless devices receive the CTS messages controls which of the wireless devices communicate concurrently with the wireless devices 702, 704. As such, the wireless device 704 may transmit the CTS message with a power such that the wireless devices 706, 708 receive the CTS message with a power above a threshold and the wireless device 710 receives the CTS message with a power below a global network threshold (but still decodable). The wireless devices 706, 708 may then determine to refrain from transmitting and the wireless device 710 may then determine not to refrain from transmitting while the wireless device 704 receives the data transmission from the wireless device 702.

Many reasonable heuristics can be designed for setting a nominal SINR (with respect to which the above computations for degradation of rate are based) to obtain high spatial reuse. One heuristic for computing the nominal interference at a given receiver is provided infra. The heuristic assumes the interferer knows the interference caused by each of the interferers. The number of interferers is denoted by N. For each n=1, 2, . . . , N, a receiver computes the following:

$$rate ( n ) = C / n ( \frac{GP}{{N}_{0} + {\sum }_{k = n + 1}^{N} {I}_{k}} ) ,$$

where C(SINR) is the capacity function, G is the serving link gain to the receiver, P is the transmitter power to the receiver, Nₒ is the noise power, and Iₖ is the interference caused by the k^{th} most dominant interferer. The receiver also computes nₒₚₜ as the value of n which maximizes the rate(n). The nominal interference is then given by the following:

$${I}_{nom} = ( \frac{{C}^{- 1} ( rate ( {n}_{opt} ) )}{GP} ) - {N}_{0} .$$

Such a computation provides that (1) only dominant interferers will back off significantly; (2) for a receiver in low geometry, more interferers will back off than for a user in a high geometry; and (3) for a given geometry, if the interference comes from a large number of interferers, then the back off would be less than compared to the case when the interference comes from a smaller number of interferers. Other algorithms may be used to determine the value of the nominal interference to influence the back off behavior of other interferers. For example, only active interferers may be considered in the above computation, where an interferer is considered active if the interferer has had data to transmit over the past few subframes. Furthermore, the capacity function C could be replaced with a lookup table of SINRs to rates achieved using specific code rates, coding methods, and block sizes.

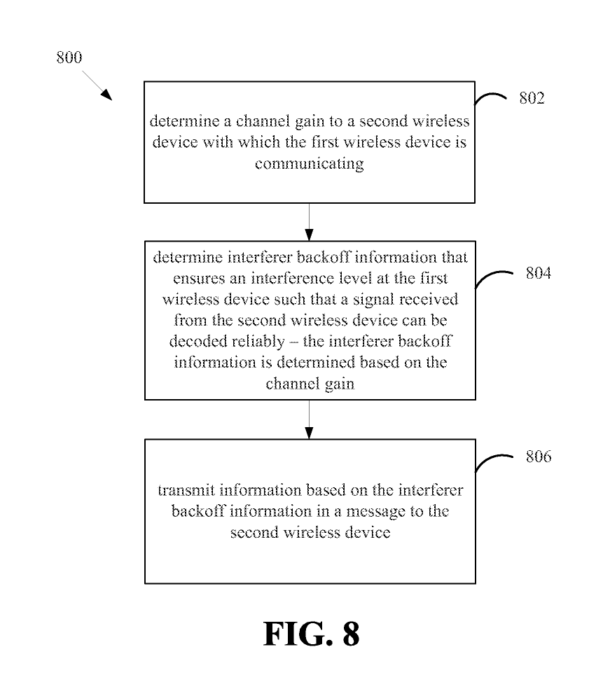

FIG. 8 is a flow chart 800 of a first method of wireless communication. The method is performed by a first wireless device. According to the method, the first wireless device determines a channel gain to a second wireless device with which the first wireless device is communicating (802). In addition, the first wireless device determines interferer backoff information that ensures an interference level at the first wireless device such that a signal received from the second wireless device can be decoded reliably (804). The interferer backoff information is determined based on the channel gain (804). Furthermore, the first wireless device transmits information based on the interferer backoff information in a message to the second wireless device (806). The interferer backoff information may be an interference level margin or a channel gain threshold.

The interference level margin is determined based on the channel gain and allows the signal received from the second wireless device to be decoded reliably. The interference level margin may be a maximum interference level under which an acknowledgment and CTS message can be successfully decoded from the second wireless device. In such a configuration, the interference level margin is transmitted in an RTS message. Alternatively, the interference level margin may be determined based on a maximum interference level under which data can be successfully decoded from the second wireless device at a desired transfer rate. In such a configuration, the interference level margin is transmitted in a CTS message.

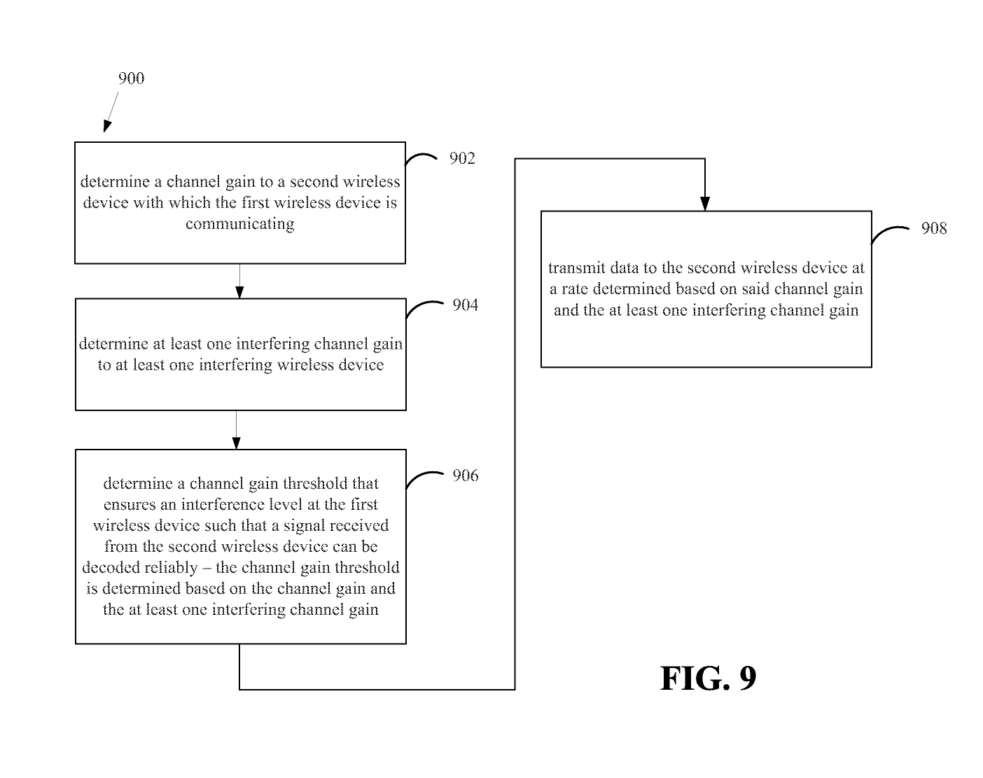

FIG. 9 is a flow chart 900 of a second method of wireless communication. The method is performed by a first wireless device. According to the method, the first wireless device determines a channel gain to a second wireless device with which the first wireless device is communicating (902). The first wireless device determines at least one interfering channel gain to at least one interfering wireless device (904). The first wireless device determines a channel gain threshold that ensures an interference level at the first wireless device such that a signal received from the second wireless device can be decoded reliably (906). The channel gain threshold is determined based on the channel gain and the at least one interfering channel gain (906). The first wireless device may transmit data to the second wireless device at a rate determined based on said channel gain and the at least one interfering channel gain (908).

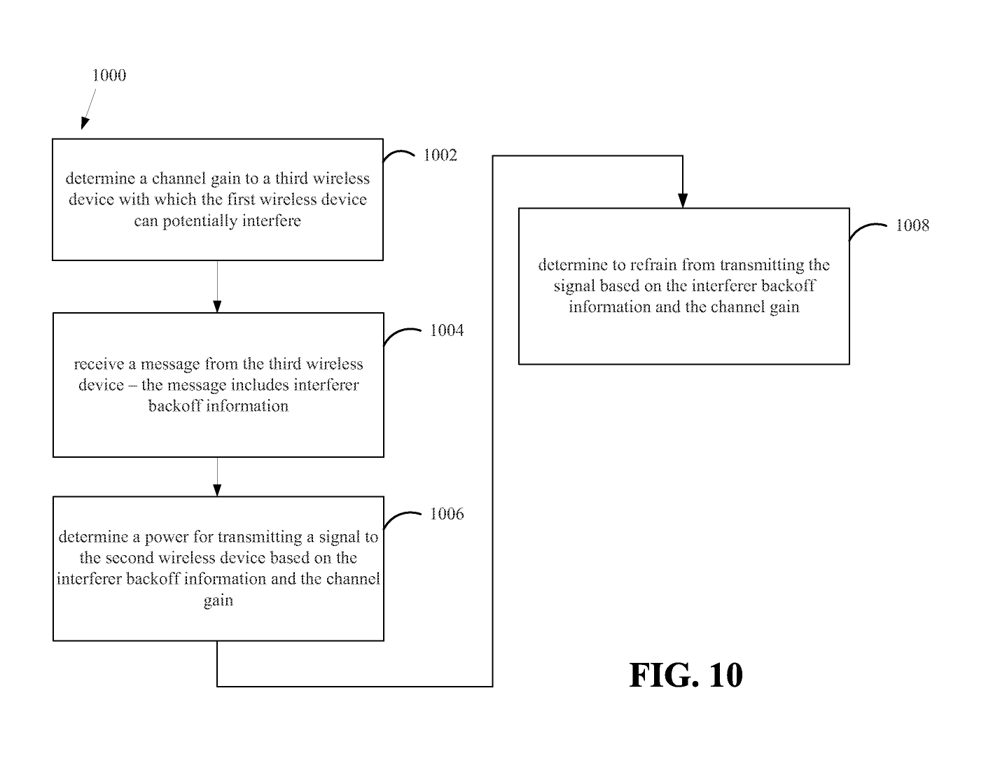

FIG. 10 is a flow chart 1000 of a third method of wireless communication. The method is performed by a first wireless device in communication (e.g., peer-to-peer communication) with a second wireless device. According to the method, the first wireless device determines a channel gain to a third wireless device with which the first wireless device can potentially interfere (1002). The first wireless device receives a message from the third wireless device (1004). The message includes interferer backoff information (1004). The first wireless device determines a power for transmitting a signal to the second wireless device based on the interferer backoff information and the channel gain (1006).

In one configuration, the interferer backoff information is a channel gain threshold, and the first wireless device determines to refrain from transmitting the signal (1008) when the channel gain to the third wireless device is greater than the channel gain threshold. If the message is an RTS message, the first wireless device may refrain from transmitting the signal while the third wireless device receives a CTS message or an acknowledgment message when said channel gain is greater than the channel gain threshold. If the message is a CTS message, the first wireless device may refrain from transmitting the signal while the third wireless device receives a data transmission when said channel gain is greater than the channel gain threshold.

In one configuration, the interferer backoff information is an interference level margin and the first wireless device determines to refrain from transmitting the signal (1008) when an interference caused to the third wireless device by transmitting the signal is greater than the interference level margin. When the message is an RTS message, the first wireless device may refrain from transmitting the signal when an interference to a CTS message or an acknowledgment message received by the third wireless device is determined to be greater than the interference level margin. In one configuration, the power is determined such that an interference caused by transmission of the signal to the third wireless device is less than the interference level margin. If the message is a CTS message, the first wireless device may refrain from transmitting the signal while the third wireless device receives a data transmission when an interference to the data transmission received by the third wireless device is determined to be greater than the interference level margin.

In one configuration, the message further includes a first rate at which the third wireless device expects to receive a transmission from a fourth wireless device. In such a configuration, the first wireless device may determine a degradation to the first rate due to a transmission of the signal to the second wireless device. The degradation to the first rate is determined based on the channel gain. In addition, the first wireless device may determine a second rate for the transmission of the signal to the second wireless device. The first wireless device may determine to transmit the signal when the second rate is greater than the degradation to the first rate.

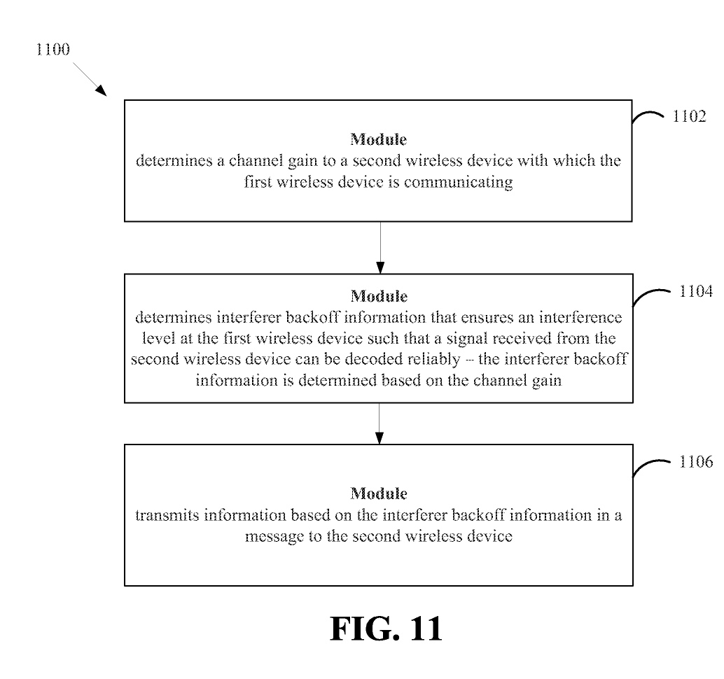

FIG. 11 is a conceptual block diagram illustrating the functionality of an exemplary apparatus 100. The apparatus 100 is a first wireless device. The first wireless device includes a module 1102 that determines a channel gain to a second wireless device with which the first wireless device is communicating. In addition, the first wireless device includes a module 1104 that determines interferer backoff information that ensures an interference level at the first wireless device such that a signal received from the second wireless device can be decoded reliably. The interferer backoff information is determined based on the channel gain. Furthermore, the first wireless device includes a module 1106 that transmits information based on the interferer backoff information in a message to the second wireless device. The first wireless device may include additional modules that perform each of the steps in the aforementioned flow charts of FIG. 8 and FIG. 9. As such, each step in the aforementioned flow charts may be performed by a module and the first wireless device may include one or more of those modules.

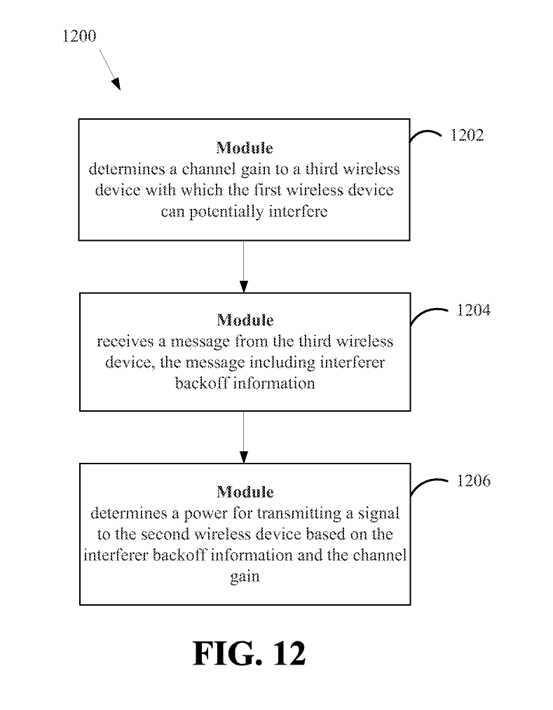

FIG. 12 is a conceptual block diagram illustrating the functionality of another exemplary apparatus 100. The apparatus 100 is a first wireless device in communication with a second wireless device. The first wireless device includes a module 1202 that determines a channel gain to a third wireless device with which the first wireless device can potentially interfere. In addition, the first wireless device includes a module 1204 that receives a message from the third wireless device. The message includes interferer backoff information. Furthermore, the first wireless device includes a module 1206 that determines a power for transmitting a signal to the second wireless device based on the interferer backoff information and the channel gain. The first wireless device may include additional modules that perform each of the steps in the aforementioned flow chart of FIG. 10. As such, each step in the aforementioned flow charts may be performed by a module and the first wireless device may include one or more of those modules.

Referring to FIG. 1, in one configuration, the first wireless device 100 includes means for determining a channel gain to a second wireless device with which the first wireless device is communicating. The first wireless device 100 further includes means for determining interferer backoff information that ensures an interference level at the first wireless device such that a signal received from the second wireless device can be decoded reliably. The interferer backoff information is determined based on the channel gain. The first wireless device 100 further includes means for transmitting information based on the interferer backoff information in a message to the second wireless device.

In one configuration, the interferer backoff information is a channel gain threshold determined based on said channel gain. In such a configuration, the first wireless device 100 may further include means for determining at least one interfering channel gain to at least one interfering wireless device. In such a configuration, the interferer backoff information is further based on the at least one interfering channel gain. The first wireless device 100 may further include means for transmitting data to the second wireless device at a rate determined based on said channel gain and the at least one interfering channel gain. The aforementioned means is the processing system 114 configured to perform the functions recited by the aforementioned means.

In another configuration, the first wireless device 100 includes means for determining a channel gain to a third wireless device with which the first wireless device can potentially interfere. In addition, the first wireless device 100 includes means for receiving a message from the third wireless device. The message includes interferer backoff information. Furthermore, the first wireless device 100 includes means for determining a power for transmitting a signal to the second wireless device based on the interferer backoff information and the channel gain. In one configuration, the interferer backoff information is a channel gain threshold and the first wireless device 100 further includes means for determining to refrain from transmitting the signal when the channel gain to the third wireless device is greater than the channel gain threshold. In one configuration, the interferer backoff information is an interference level margin and the first wireless device further includes means for determining to refrain from transmitting the signal when an interference caused to the third wireless device by transmitting the signal is greater than the interference level margin.

In one configuration, the message further includes a first rate at which the third wireless device expects to receive a transmission from a fourth wireless device. In such a configuration, the first wireless device 100 further includes means for determining a degradation to the first rate due to a transmission of the signal to the second wireless device. The degradation to the first rate is determined based on said channel gain. The first wireless device 100 further includes means for determining a second rate for the transmission of the signal to the second wireless device. In one configuration, the first wireless device 100 further includes means for determining to transmit the signal when the second rate is greater than the degradation to the first rate. The aforementioned means is the processing system 114 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of operating a first wireless device, comprising:
determining a channel gain to a second wireless device with which the first wireless device is communicating;
determining interferer backoff information that ensures an interference level at the first wireless device such that a signal received from the second wireless device can be decoded reliably, the interferer backoff information being determined based on the channel gain; and
transmitting information based on the interferer backoff information in a message to the second wireless device.

2. The method of claim 1, wherein the interferer backoff information is a channel gain threshold determined based on said channel gain.

3. The method of claim 2, further comprising determining at least one interfering channel gain to at least one interfering wireless device, wherein the interferer backoff information is further based on the at least one interfering channel gain.

4. The method of claim 3, further comprising transmitting data to the second wireless device at a rate determined based on said channel gain and the at least one interfering channel gain.

5. The method of claim 1, wherein the interferer backoff information is an interference level margin determined based on said channel gain that allows the signal received from the second wireless device to be decoded reliably.

6. The method of claim 5, wherein the interference level margin is a maximum interference level under which an acknowledgment and clear to send (CTS) message can be successfully decoded from the second wireless device.

7. The method of claim 6, wherein the interference level margin is transmitted in a request to send (RTS) message.

8. The method of claim 5, wherein the interference level margin is determined based on a maximum interference level under which data can be successfully decoded from the second wireless device at a desired transfer rate.

9. The method of claim 8, wherein the interference level margin is transmitted in a clear to send (CTS) message.

10. A method of operating a first wireless device in communication with a second wireless device, comprising:
determining a channel gain to a third wireless device with which the first wireless device can potentially interfere;
receiving a message from the third wireless device, the message including interferer backoff information; and
determining a power for transmitting a signal to the second wireless device based on the interferer backoff information and the channel gain.

11. The method of claim 10, wherein the interferer backoff information is a channel gain threshold, the method further comprising determining to refrain from transmitting the signal when the channel gain to the third wireless device is greater than the channel gain threshold.

12. The method of claim 11, wherein the message is a request to send (RTS) message and the first wireless device refrains from transmitting the signal while the third wireless device receives a clear to send (CTS) message or an acknowledgment message when said channel gain is greater than the channel gain threshold.

13. The method of claim 10, wherein the interferer backoff information is an interference level margin, the method further comprising determining to refrain from transmitting the signal when an interference caused to the third wireless device by transmitting the signal is greater than the interference level margin.

14. The method of claim 13, wherein the message is a request to send (RTS) message and the first wireless device refrains from transmitting the signal when an interference to a clear to send (CTS) message or an acknowledgment message received by the third wireless device is determined to be greater than the interference level margin.

15. The method of claim 13, wherein the power is determined such that an interference caused by transmission of the signal to the third wireless device is less than the interference level margin.

16. The method of claim 10, wherein the message is a clear to send (CTS) message and the first wireless device determines to refrain from transmitting the signal while the third wireless device receives a data transmission based on the interferer backoff information.

17. The method of claim 10, wherein the message further includes a first rate at which the third wireless device expects to receive a transmission from a fourth wireless device, the method further comprising:
determining a degradation to the first rate due to a transmission of the signal to the second wireless device, the degradation to the first rate being determined based on said channel gain; and
determining a second rate for the transmission of the signal to the second wireless device.

18. The method of claim 17, further comprising determining to transmit the signal when the second rate is greater than the degradation to the first rate.

19. A first wireless device for wireless communication, comprising:
means for determining a channel gain to a second wireless device with which the first wireless device is communicating;
means for determining interferer backoff information that ensures an interference level at the first wireless device such that a signal received from the second wireless device can be decoded reliably, the interferer backoff information being determined based on the channel gain; and
means for transmitting information based on the interferer backoff information in a message to the second wireless device.

20. The first wireless device of claim 19, wherein the interferer backoff information is a channel gain threshold determined based on said channel gain.

21. The first wireless device of claim 20, further comprising means for determining at least one interfering channel gain to at least one interfering wireless device, wherein the interferer backoff information is further based on the at least one interfering channel gain.

22. The first wireless device of claim 21, further comprising means for transmitting data to the second wireless device at a rate determined based on said channel gain and the at least one interfering channel gain.

23. The first wireless device of claim 19, wherein the interferer backoff information is an interference level margin determined based on said channel gain that allows the signal received from the second wireless device to be decoded reliably.

24. The first wireless device of claim 23, wherein the interference level margin is a maximum interference level under which an acknowledgment and clear to send (CTS) message can be successfully decoded from the second wireless device.

25. The first wireless device of claim 24, wherein the interference level margin is transmitted in a request to send (RTS) message.

26. The first wireless device of claim 23, wherein the interference level margin is determined based on a maximum interference level under which data can be successfully decoded from the second wireless device at a desired transfer rate.

27. The first wireless device of claim 26, wherein the interference level margin is transmitted in a clear to send (CTS) message.

28. A first wireless device for communicating with a second wireless device, the first wireless device comprising:
means for determining a channel gain to a third wireless device with which the first wireless device can potentially interfere;
means for receiving a message from the third wireless device, the message including interferer backoff information; and
means for determining a power for transmitting a signal to the second wireless device based on the interferer backoff information and the channel gain.

29. The first wireless device of claim 28, wherein the interferer backoff information is a channel gain threshold, the first wireless device further comprising means for determining to refrain from transmitting the signal when the channel gain to the third wireless device is greater than the channel gain threshold.

30. The first wireless device of claim 29, wherein the message is a request to send (RTS) message and the first wireless device refrains from transmitting the signal while the third wireless device receives a clear to send (CTS) message or an acknowledgment message when said channel gain is greater than the channel gain threshold.

31. The first wireless device of claim 28, wherein the interferer backoff information is an interference level margin, the first wireless device further comprising means for determining to refrain from transmitting the signal when an interference caused to the third wireless device by transmitting the signal is greater than the interference level margin.

32. The first wireless device of claim 31, wherein the message is a request to send (RTS) message and the first wireless device refrains from transmitting the signal when an interference to a clear to send (CTS) message or an acknowledgment message received by the third wireless device is determined to be greater than the interference level margin.

33. The first wireless device of claim 31, wherein the power is determined such that an interference caused by transmission of the signal to the third wireless device is less than the interference level margin.

34. The first wireless device of claim 28, wherein the message is a clear to send (CTS) message and the first wireless device determines to refrain from transmitting the signal while the third wireless device receives a data transmission based on the interferer backoff information.

35. The first wireless device of claim 28, wherein the message further includes a first rate at which the third wireless device expects to receive a transmission from a fourth wireless device, the first wireless device further comprising:
means for determining a degradation to the first rate due to a transmission of the signal to the second wireless device, the degradation to the first rate being determined based on said channel gain; and
means for determining a second rate for the transmission of the signal to the second wireless device.

36. The first wireless device of claim 35, further comprising means for determining to transmit the signal when the second rate is greater than the degradation to the first rate.

37. A first wireless device for wireless communication, comprising:
a processing system configured to:
determine a channel gain to a second wireless device with which the first wireless device is communicating;
determine interferer backoff information that ensures an interference level at the first wireless device such that a signal received from the second wireless device can be decoded reliably, the interferer backoff information being determined based on the channel gain; and
transmit information based on the interferer backoff information in a message to the second wireless device.

38. The first wireless device of claim 37, wherein the interferer backoff information is a channel gain threshold determined based on said channel gain.

39. The first wireless device of claim 38, wherein the processing system is further configured to determine at least one interfering channel gain to at least one interfering wireless device, wherein the interferer backoff information is further based on the at least one interfering channel gain.

40. The first wireless device of claim 39, wherein the processing system is further configured to transmit data to the second wireless device at a rate determined based on said channel gain and the at least one interfering channel gain.

41. The first wireless device of claim 37, wherein the interferer backoff information is an interference level margin determined based on said channel gain that allows the signal received from the second wireless device to be decoded reliably.

42. The first wireless device of claim 41, wherein the interference level margin is a maximum interference level under which an acknowledgment and clear to send (CTS) message can be successfully decoded from the second wireless device.

43. The first wireless device of claim 42, wherein the interference level margin is transmitted in a request to send (RTS) message.

44. The first wireless device of claim 41, wherein the interference level margin is determined based on a maximum interference level under which data can be successfully decoded from the second wireless device at a desired transfer rate.

45. The first wireless device of claim 44, wherein the interference level margin is transmitted in a clear to send (CTS) message.

46. A first wireless device for communicating with a second wireless device, comprising:
a processing system configured to:
determine a channel gain to a third wireless device with which the first wireless device can potentially interfere;
receive a message from the third wireless device, the message including interferer backoff information; and
determine a power for transmitting a signal to the second wireless device based on the interferer backoff information and the channel gain.

47. The first wireless device of claim 46, wherein the interferer backoff information is a channel gain threshold, wherein the processing system is further configured to determine to refrain from transmitting the signal when the channel gain to the third wireless device is greater than the channel gain threshold.

48. The first wireless device of claim 47, wherein the message is a request to send (RTS) message and the first wireless device refrains from transmitting the signal while the third wireless device receives a clear to send (CTS) message or an acknowledgment message when said channel gain is greater than the channel gain threshold.

49. The first wireless device of claim 46, wherein the interferer backoff information is an interference level margin, wherein the processing system is further configured to determine to refrain from transmitting the signal when an interference caused to the third wireless device by transmitting the signal is greater than the interference level margin.

50. The first wireless device of claim 49, wherein the message is a request to send (RTS) message and the first wireless device refrains from transmitting the signal when an interference to a clear to send (CTS) message or an acknowledgment message received by the third wireless device is determined to be greater than the interference level margin.

51. The first wireless device of claim 49, wherein the power is determined such that an interference caused by transmission of the signal to the third wireless device is less than the interference level margin.

52. The first wireless device of claim 46, wherein the message is a clear to send (CTS) message and the first wireless device determines to refrain from transmitting the signal while the third wireless device receives a data transmission based on the interferer backoff information.

53. The first wireless device of claim 46, wherein the message further includes a first rate at which the third wireless device expects to receive a transmission from a fourth wireless device, wherein the processing system is further configured to:
determine a degradation to the first rate due to a transmission of the signal to the second wireless device, the degradation to the first rate being determined based on said channel gain; and
determine a second rate for the transmission of the signal to the second wireless device.

54. The first wireless device of claim 53, wherein the processing system is further configured to determine to transmit the signal when the second rate is greater than the degradation to the first rate.

55. A computer program product in a first wireless device, comprising:
a computer-readable medium comprising code for:
determining a channel gain to a second wireless device with which the first wireless device is communicating;
determining interferer backoff information that ensures an interference level at the first wireless device such that a signal received from the second wireless device can be decoded reliably, the interferer backoff information being determined based on the channel gain; and
transmitting information based on the interferer backoff information in a message to the second wireless device.

56. A computer program product in a first wireless device for communicating with a second wireless device, comprising:
a computer-readable medium comprising code for:
determining a channel gain to a third wireless device with which the first wireless device can potentially interfere;
receiving a message from the third wireless device, the message including interferer backoff information; and
determining a power for transmitting a signal to the second wireless device based on the interferer backoff information and the channel gain.
